(19) United States
(12) Patent Application Publication
(10) Pub. No.: US 2011/0179682 A1
(43) Pub. Date: Jul. 28, 2011

(54) FLOWING SAND PICTURE

(76) Inventor: CHENG-HSIUNG LIN, TAIPEI CITY (TW)

(21) Appl. No.: 12/692,899

(22) Filed: Jan. 25, 2010

(51) Int. Cl. G09F 19/02

(52) U.S. Cl. 40/409

(57) ABSTRACT

A flowing sand picture flowing sand picture includes a transparent, flat box-like picture frame holding therein a fluid, multiple heavy granular materials and multiple lightweight granular materials. Each heavy granular material has a specific gravity higher than the fluid and each lightweight granular material has a specific gravity lower than the fluid. When the transparent, flat box-like picture frame is turned upside down, the granular materials float up and down through one another, showing a picture of dynamic variation.

### BACKGROUND OF THE INVENTION

1. Field of the Invention

The present invention relates to sand pictures and more particularly, to a flowing sand picture, which has granular materials of different sizes, colors and specific gravities held in a liquid inside a transparent, flat box-like picture frame such that when the transparent, flat box-like picture frame is turned upside down, the granular materials float up and down through one another, showing a picture of dynamic variation.

2. Description of the Related Art

FIG. 1 illustrates a flowing sand picture according to the prior art. According to this design, the flowing sand picture comprises a transparent flat box-like picture frame 1 having sealed therein a fluid 11 (water or oil) and a granular material 12 (for example, sand) that has a specific gravity higher than the fluid 11. When the transparent flat box-like picture frame 1 is turned upside down, the granular material 12 flows down in the fluid 11 rapidly and bubbles 13 are produced and flowing upwards in the fluid 11. The upwardly flowing bubbles 13 slow down the downward flowing speed of the granular material 12. Thus, a variation of picture is seen.

According to the aforesaid prior art design, the bubbles 13 will disappear within a very short time after the transparent flat box-like picture frame 1 is still. When the bubbles disappeared, the multi-layer picture pattern disappears too. Further, the scene in which bubbles are mixed in the sand is not attractive.

### SUMMARY OF THE INVENTION

The present invention has been accomplished under the circumstances in view. It is therefore the main object of the present invention to provide a flowing sand picture, which causes granular materials of different specific gravities to flow through one another in two reversed directions in a fluid when it is turned upside down, thereby showing a picture of dynamic variation.

To achieve this and other objects of the present invention, a flowing sand picture comprises a transparent, flat box-like picture frame, a fluid sealed in the transparent, flat box-like picture frame, multiple heavy granular materials sealed in the transparent, flat box-like picture frame, each heavy granular material having a specific gravity higher than the fluid, and multiple lightweight granular materials sealed in the transparent, flat box-like picture frame, each lightweight granular material having a specific gravity lower than the fluid.

When the transparent, flat box-like picture frame is turned upside down, the heavy granular materials float down in the fluid and the lightweight granular materials float up in the fluid through the heavy granular materials, showing a picture of dynamic variation.

Further, a rack may be provided to support the transparent, flat box-like picture frame for allowing the transparent, flat box-like picture frame to be rotated relative to the rack. Further, the heavy granular materials and the lightweight granular materials can be prepared in different colors and/or different sizes.

### BRIEF DESCRIPTION OF THE DRAWINGS

FIG. 1 is a front view of a flowing sand picture according to the prior art.

FIG. 2 is a schematic front view of a flowing sand picture according to a first embodiment of the present invention.

FIG. 3 is a front view of the first embodiment of the present invention, showing the flowing sand picture kept stilled.

FIG. 4 is a sectional view of the flowing sand picture in accordance with the first embodiment of the present invention.

FIG. 5 illustrates a flowing sand picture in accordance with a second embodiment of the present invention.

FIG. 6 is a schematic front view of a flowing sand picture in accordance with a third embodiment of the present invention.

FIG. 7 is a front view of the third embodiment of the present invention, showing the flowing sand picture kept stilled.

FIG. 8 is a sectional view of the flowing sand picture in accordance with the third embodiment of the present invention.

FIG. 9 illustrates a flowing sand picture in accordance with a fourth embodiment of the present invention.

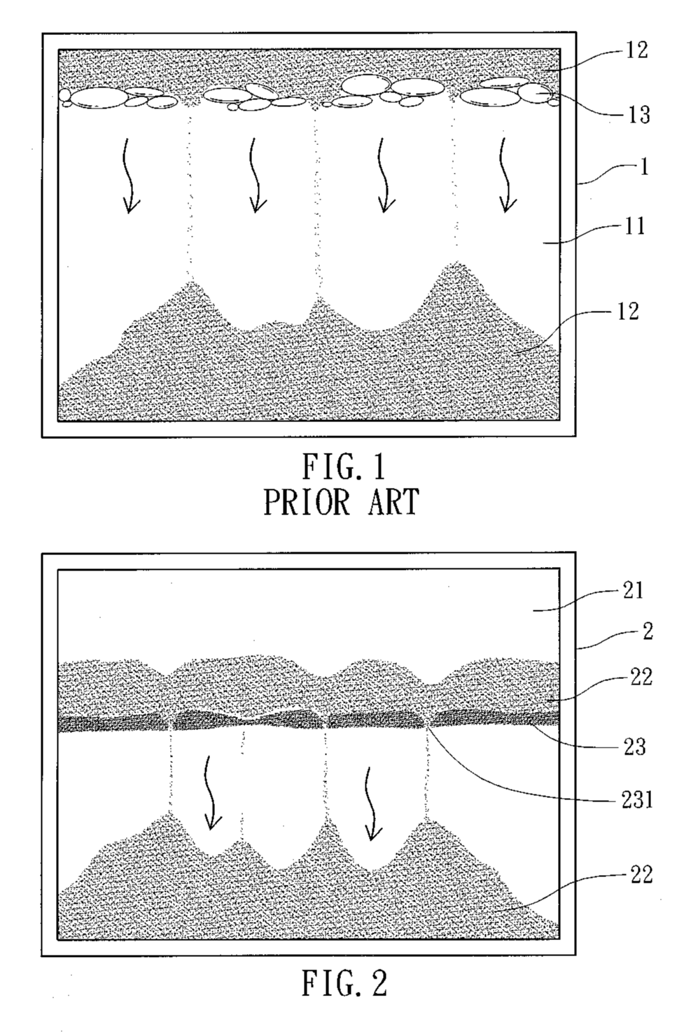

### DETAILED DESCRIPTION OF THE PREFERRED EMBODIMENT

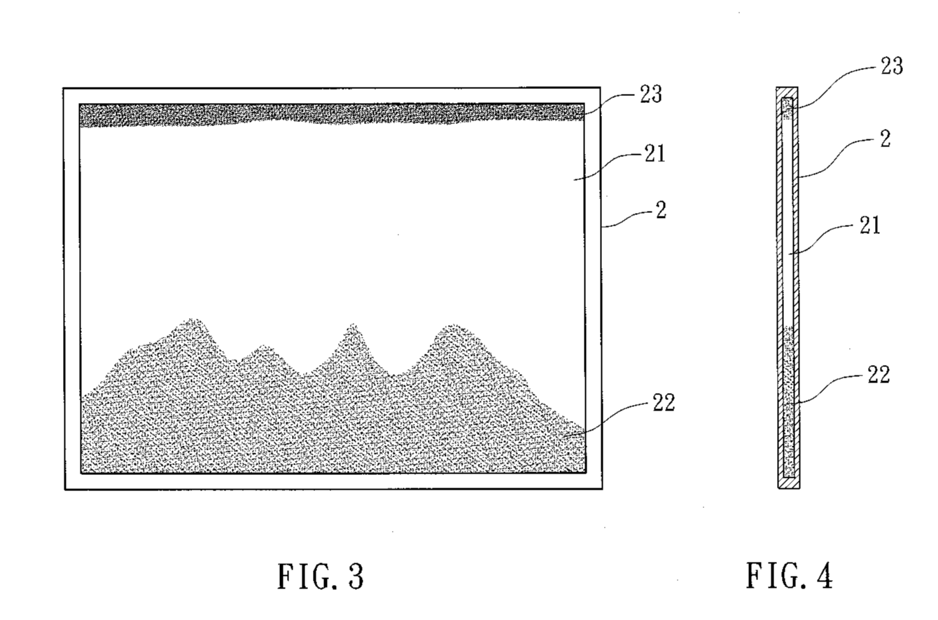

Referring to FIGS. 2, 3 and 4, a flowing sand picture in accordance with a first embodiment of the present invention is shown comprising a transparent, flat box-like picture frame 2, a fluid 21 filled in the transparent, flat box-like picture frame 2, multiple heavy granular materials 22 filled in the transparent, flat box-like picture frame 2 and multiple lightweight granular materials 23 filled in the transparent, flat box-like picture frame 2. Each heavy granular material 22 has a specific gravity higher than the fluid 21. Each lightweight granular material 23 has a specific gravity lower than the fluid 21. It is to be understood that the transparent, flat box-like picture frame 2 has a filling hole (not shown), which is sealed after filling of the fluid 21, the heavy granular materials 22 and the lightweight granular materials 23. When the transparent, flat box-like picture frame 2 is turned upside down, the lightweight granular materials 23 float rapidly upwards in the fluid 21 and the lightweight granular materials 23 sink in the fluid 21 through gaps 231 among the upwardly floating lightweight granular materials 23 subject to the effect that the lightweight granular materials 23 have more buoyancy than the fluid 21 and the effect that each heavy granular material 22 has a specific gravity higher than the fluid 21. During upward movement of the lightweight granular materials 23 and downward movement of the heavy granular materials 22 in the fluid 21, a picture of dynamic variation is seen. Further, the amount of the lightweight granular materials 23 must be properly controlled. If the amount of the lightweight granular materials 23 is excessively high, the lightweight granular materials 23 will prohibit the heavy granular materials 22 from falling to the bottom side in the fluid 21. If the amount of the lightweight granular materials 23 is excessively low, the heavy granular materials 22 will fall to the bottom side in the fluid 21 rapidly, the duration of the dynamic variation of the picture will be greatly shortened.

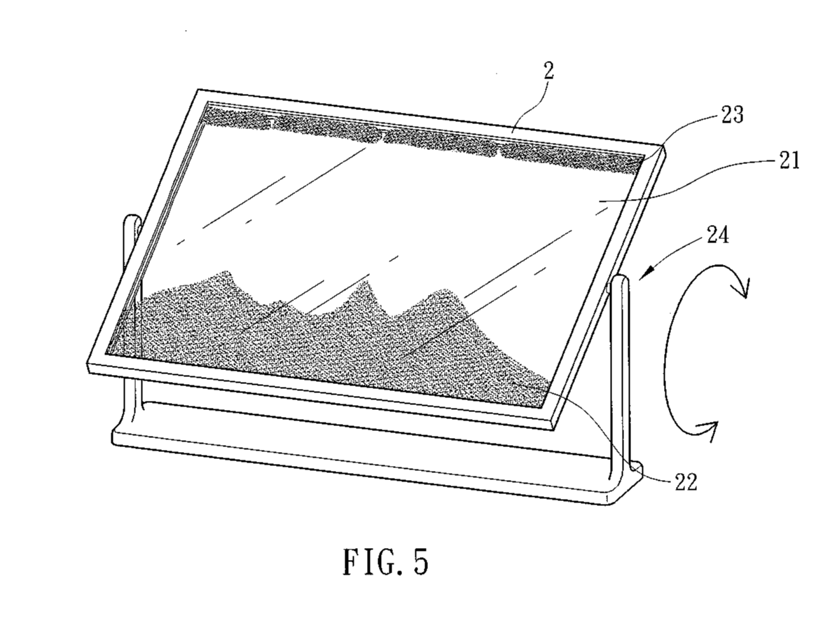

FIG. 5 illustrates a flowing sand picture in accordance with a second embodiment of the present invention. This second embodiment is substantially similar to the aforesaid first embodiment with the exception of that the transparent, flat box-like picture frame 2 is pivotally supported on a rack 24 so that the user can swing the transparent, flat box-like picture frame 2 back and forth on the rack 24.

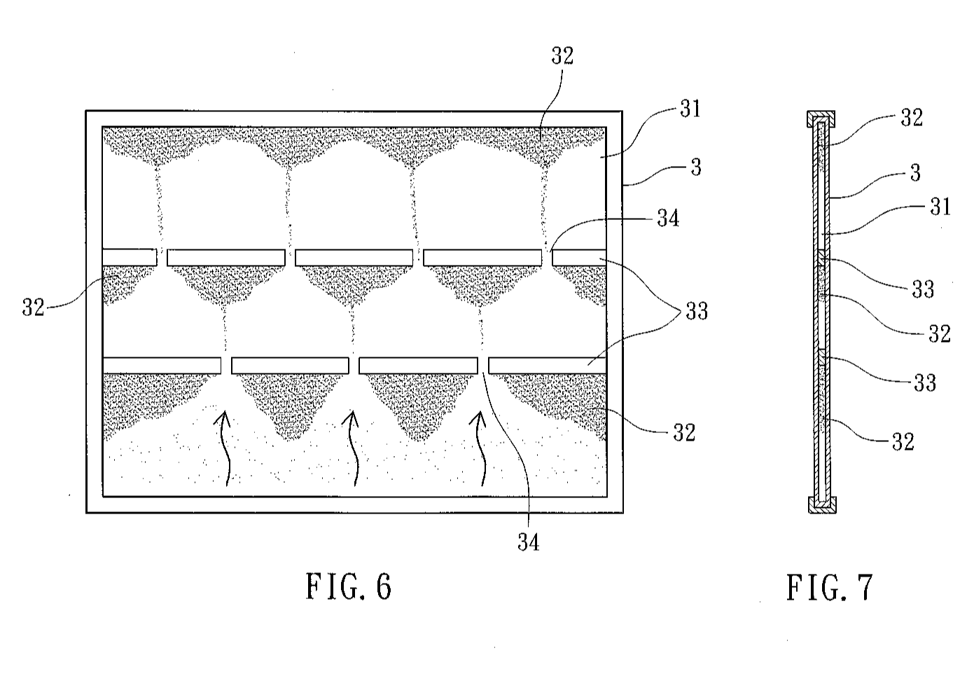

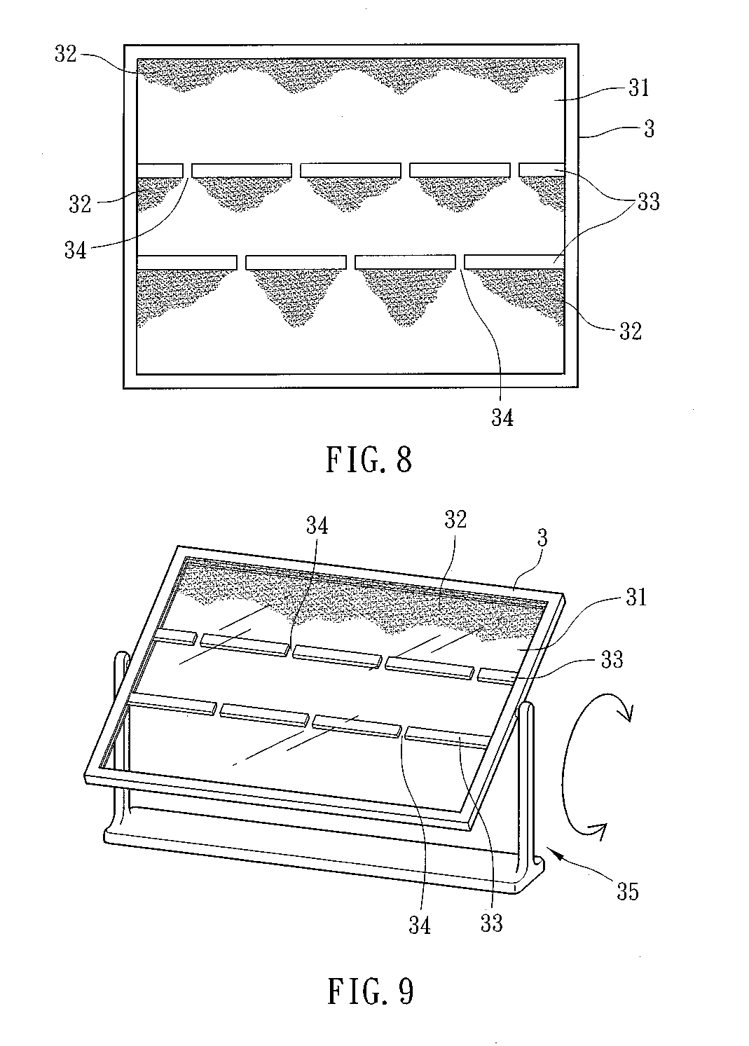

FIGS. 6-8 illustrate a flowing sand picture in accordance with a third embodiment of the present invention. The flowing sand picture according to this third embodiment comprises a transparent, flat box-like picture frame 3, a fluid 31 filled in the transparent, flat box-like picture frame 3, multiple lightweight granular materials 32 filled in the transparent, flat box-like picture frame 3 and multiple barriers 33 fixedly mounted in the transparent, flat box-like picture frame 3 at selected locations and spaced from one another by gaps 34. The barriers 33 can be made from transparent acrylic or glass in any of a variety of shapes. Each lightweight granular material 32 has a specific gravity lower than the fluid 31. Further, the barriers 33 can be arranged in straight or curved lines at different elevations. When the transparent, flat box-like picture frame 3 is turned upside down, the lightweight granular materials 32 float rapidly upwards in the fluid 31 through the gaps 34, showing a picture of dynamic variation.

FIG. 9 illustrates a flowing sand picture in accordance with a fourth embodiment of the present invention. This fourth embodiment is substantially similar to the aforesaid third embodiment with the exception of that the transparent, flat box-like picture frame 3 is pivotally supported on a rack 35 so that the user can swing the transparent, flat box-like picture frame 3 back and forth on the rack 35.

Further, the aforesaid heavy granular materials 22, lightweight granular materials 23 and lightweight granular materials 32 can be made in different sizes and different colors for showing a color variation.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A flowing sand picture, comprising:
a transparent, flat box-like picture frame;
a fluid sealed in said transparent, flat box-like picture frame;
multiple heavy granular materials sealed in said transparent, flat box-like picture frame, each said heavy granular material having a specific gravity higher than said fluid; and
multiple lightweight granular materials sealed in said transparent, flat box-like picture frame, each said lightweight granular material having a specific gravity lower than said fluid.

2. The flowing sand picture as claimed in claim 1, further comprising a rack supporting said transparent, flat box-like picture frame for allowing said transparent, flat box-like picture frame to be rotated relative to said rack.

3. The flowing sand picture as claimed in claim 1, wherein said heavy granular materials have different colors.

4. The flowing sand picture as claimed in claim 1, wherein said lightweight granular materials have different colors.

5. A flowing sand picture, comprising:
a transparent, flat box-like picture frame;
a plurality of barriers fixedly mounted in said transparent, flat box-like picture frame at selected locations and spaced from one another by gaps;
a fluid sealed in said transparent, flat box-like picture frame; and
multiple lightweight granular materials sealed in said transparent, flat box-like picture frame, each said lightweight granular material having a specific gravity lower than said fluid.

6. The flowing sand picture as claimed in claim 5, wherein said barriers are transparent.

7. The flowing sand picture as claimed in claim 5, wherein said barriers are arranged in straight lines at different elevations.

8. The flowing sand picture as claimed in claim 5, wherein said barriers are arranged in curved lines at different elevations.

9. The flowing sand picture as claimed in claim 5, wherein said lightweight granular materials have different colors.

10. The flowing sand picture as claimed in claim 5, wherein said lightweight granular materials have different sizes.
